(19) United States
(12) Patent Application Publication
(10) Pub. No.: US 2012/0162684 A1
(43) Pub. Date: Jun. 28, 2012

(54) IMAGE PROCESSING APPARATUS AND COMPUTER PROGRAM PRODUCT

(75) Inventors: Fabrice Matulic, Tokyo (JP); Fumihiro Hasegawa, Tokyo (JP)

(73) Assignee: RICOH COMPANY, LIMITED, Ohta-ku, Tokyo (JP)

(21) Appl. No.: 13/393,880

(22) PCT Filed: Sep. 14, 2010
(86) PCT No.: PCT/JP2010/066271

§ 371 Date: Mar. 7, 2012

(30) Foreign Application Priority Data
Sep. 14, 2009 (JP) 2009-212470

(51) Int. Cl. G06F 15/00; H04N 1/40

(52) U.S. Cl. 358/1.13; 358/448

(57) ABSTRACT

An image processing apparatus obtains image data of a document in response to an instruction from a user, and processes and outputs the image data thus obtained. The image processing apparatus includes a type detecting unit that detects a type of the document, a processing unit that applies a process to the image data thus obtained based on the instruction from the user, and a controlling unit that starts the processing unit when the type of the document thus detected is a predetermined type.

### TECHNICAL FIELD

The present invention relates to an image processing apparatus and a computer program product.

### BACKGROUND ART

Recently, protecting confidential information that should be protected against external leakage, e.g., private information or corporate information, has become an important issue, and some image processing apparatuses, such as multifunction products having a copying function and a printing function, process an output document not to contain any confidential information to prevent leakage of information that should be protected.

To prevent leakage of confidential information, Patent Document 1 (see Japanese Patent Application Laid-open No. 2004-274092) has proposed a technology for preventing leakage of confidential information by applying a predetermined pattern, e.g., a pattern of dots suggesting that copying is prohibited, to a document containing confidential information (hereinafter, referred to as “confidential document”) so that the confidential document is protected against being copied.

In the technology disclosed in Patent Document 1, because the entire surface of the confidential document is painted out, or the output of a document including confidential information is stopped, it has not been possible to prevent a part of the information from being copied. In view of this, according to Patent Document 2 (see Japanese Patent Application Laid-open No. 2007-124169), a copy is partially prohibited by applying a pattern to a position at which a copy should be prohibited in a confidential document.

In the technology proposed in Patent Document 2, the position at which the copy is prohibited is preset using a dot pattern. Therefore, a part of a document can be prohibited from being copied in a manner reflecting the intention of an author of the confidential document, and also the confidential document is prevented from being copied due to carelessness of a user giving an instruction to make a copy. However, it has not been possible to prohibit a part of a document from being copied in a manner reflecting the intention of the user giving an instruction to make a copy. For example, when an input document is a confidential document, the user cannot give an instruction to process the confidential document not to contain any confidential information, e.g., so that the confidential document is adjusted to disclose information to an extent not to identify the contents. Thus, it has been impossible to reflect the intention of the user.

The present invention has been made to solve the above problems in the conventional technologies and it is an object of the present invention to provide an image processing apparatus and a computer program that allow the output of part of confidential information desired by a user who instructs to output the confidential information while preventing the confidential information from being accidentally output.

### DISCLOSURE OF INVENTION

According to one aspect of the present invention, an image processing apparatus obtains image data of a document in response to an instruction from a user, and processes and outputs the image data thus obtained. The image processing apparatus includes a type detecting unit that detects a type of the document, a processing unit that applies a process to the image data thus obtained based on an instruction from the user, and a controlling unit that starts or boots the processing unit when the type of the document thus detected is a predetermined type.

According to another aspect of the present invention, a computer program product that, when executed, causes a computer that obtains image data of a document in response to an instruction from a user to process and output the image data thus obtained to perform: a step of detecting a type of the document; a step of displaying a menu for applying a process to the image data thus obtained on a displaying unit when the type of the document thus detected is a predetermined type; and a step of applying a process to the image data based on the instruction from the user entered via the menu thus displayed.

According to one aspect of the present invention, it is possible to enable the output of part of confidential information desired by a user who instructs to output the confidential information as well as to prevent the confidential information from being accidentally output.

### BRIEF DESCRIPTION OF DRAWINGS

FIG. 1 is a schematic of a hardware configuration of a multifunction product according to a first embodiment of the present invention.

FIG. 2 is a functional block diagram of the multifunction product according to the first embodiment.

FIG. 3 is a schematic of an example of data for type detection stored in a storage unit.

FIG. 4 is a schematic of an example of an image that a display controlling unit causes a displaying unit to display.

FIG. 5 is a schematic of an example of an image that the display controlling unit causes the displaying unit to display.

FIG. 6 is a flowchart for the multifunction product according to the first embodiment.

FIG. 7 is a flowchart of a document type detecting process.

FIG. 8 is a functional block diagram of a multifunction product according to a second embodiment of the present invention.

FIG. 9 is a flowchart of a process performed by a type detecting unit according to the second embodiment.

FIG. 10 is a schematic of an example of stored image data stored in a storage unit.

FIG. 11 is a functional block diagram of a multifunction product according to a third embodiment of the present invention.

FIG. 12 is a flowchart of a process performed by a processing unit according to the third embodiment.

FIG. 13 is a schematic of an example of an image that the display controlling unit causes the displaying unit to display.

FIG. 14 is a functional block diagram of a multifunction product according to a fourth embodiment of the present invention.

FIG. 15 is a flowchart for the multifunction product according to the fourth embodiment.

### BEST MODE(S) FOR CARRYING OUT THE INVENTION

Exemplary embodiments of an image processing apparatus and a computer program according to the present invention are described below in grater detail with reference to the accompanying drawings. Elements having substantially the same functions are given with the same reference numerals in the specification and the drawings, and redundant explanations thereof are omitted herein.

### First Embodiment

In a first embodiment of the present invention, a method for controlling to process an image of a confidential document, upon copying the confidential document containing confidential information such as a passport or a health insurance card, will be explained. In an explanation of the first embodiment, a multifunction product is used as an example of the image processing apparatus. A multifunction product herein is an image processing apparatus that implements a plurality of functions such as those of a printer, a copier, a scanner, and a facsimile, for example, within a single unit. Needless to say, the image processing apparatus is not limited to an image forming apparatus such as a multifunction product, a facsimile, or a printer that forms image data on a recording medium, but also includes a personal computer (PC), a mobile telephone, a personal digital assistant (PDA), and the like.

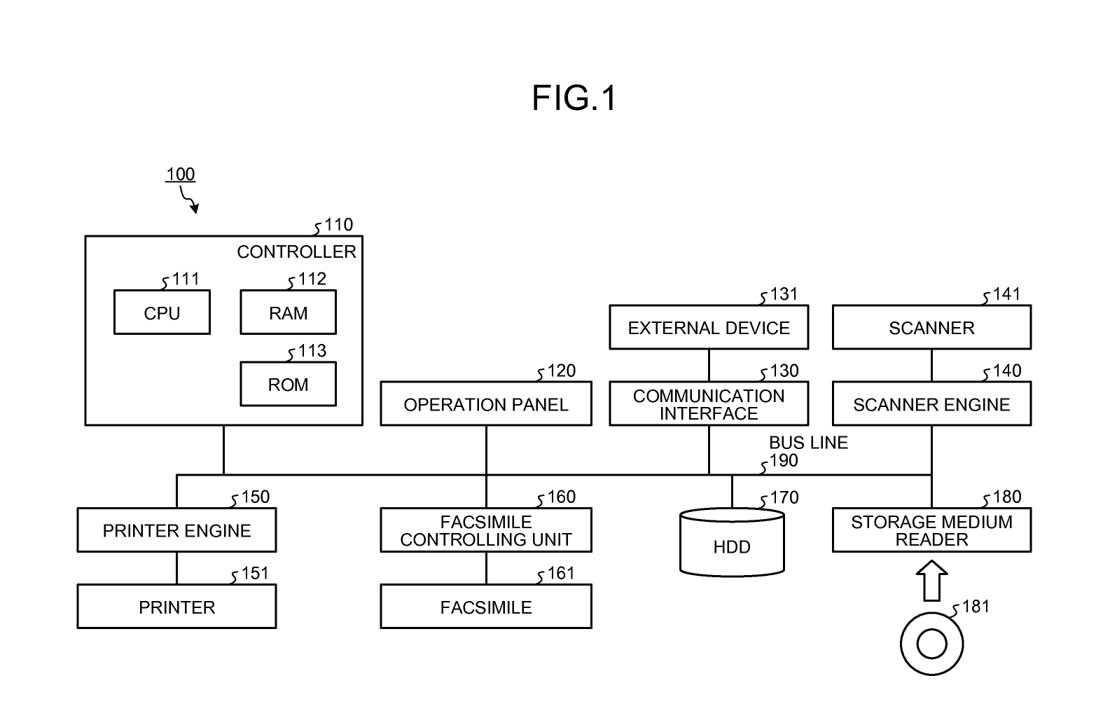

FIG. 1 is a schematic of a hardware configuration of a multifunction product 100 according to the first embodiment. The hardware configuration of the multifunction product 100 includes a controller 110, an operation panel 120, a communication interface 130, a scanner engine 140, a printer engine 150, a facsimile controlling unit 160, a hard disk drive (HDD) 170, and a storage medium reader 180. In the multifunction product 100, these units are connected via a bus line 190. Each of these units will now be explained.

The controller 110 includes a central processing unit (CPU) 111, a random access memory (RAM) 112, and a read-only memory (ROM) 113.

The CPU 111 controls each of the units illustrated in FIG. 1, and controls the entire multifunction product 100. The CPU 111 reads a necessary computer program from the ROM 113 or the HDD 170, and performs a process based on the read program to control each of the units.

The RAM 112 is a storage medium for temporarily storing or loading a program read by the CPU 111, or image data received from the communication interface 130, the scanner engine 140, and like. In other words, the RAM 112 functions as a work area for the CPU 111.

The ROM 113 is a read-only memory for storing therein various data such as computer programs. Examples of the data stored in the ROM 113 include a booting program, an operating system (OS), and various application programs for the multifunction product 100.

The operation panel 120 is controlled by the controller 110, and not only sends various setting information, such as a selection of a function or an execution command received from an operator (user) of the multifunction product 100 to the controller 110, but also displays information, such as alternatives of functions, a status of progress, and the like, received from the controller 110. The operation panel 120 may include a display (e.g., liquid crystal display (LCD) or a cathode ray tube (CRT)) and instruction entry buttons, or may be a touch panel where the display and the instruction entry buttons are integrated.

The communication interface 130 is controlled by the controller 110, and communicates with an external device 131 on the multifunction product 100. The communication interface 130 may be an Ethernet (registered trademark) interface, an IEEE 1284 interface, or any other interface.

The scanner engine 140 is controlled by the controller 110, and has a function for executing an image reading process. In other words, the scanner engine 140 reads a document using a scanner 141 to obtain image data of the document, and sends the obtained image data to the RAM 112 or the HDD 170.

The image data of a document may be not only input by means of reading performed by the scanner engine 140, but also received from the external device 131 by way of a communication performed with the external device 131 via the communication interface 130. The image data of a document may also be input by reading information recorded in a storage medium 181 that is to be described later.

The printer engine 150 is controlled by the controller 110, and executes an image forming process (printing process) using a printer 151. The printer 151 can employ various types of image forming methods, such as an electrophotographic method, or an ink jet method.

The facsimile controlling unit 160 is controlled by the controller 110, and executes a facsimile communicating process using a facsimile 161.

The HDD 170 reads or writes various data from and to a hard disk under the control of the controller 110. The hard disk, to and from which data is written and read, and a hard disk reader are collectively explained as the HDD 170. However, the HDD 170 may include only the reader.

The storage medium reader 180 is controlled by the controller 110, and executes a process of reading recorded information recorded in the storage medium 181 such as an integrated circuit (IC) card or a floppy (registered trademark) disk. In response to an instruction issued by the controller 110, the storage medium reader 180 makes an access to the storage medium 181, reads recorded information from the storage medium 181, and outputs the read information to the controller 110.

The bus line 190 electrically connects each of these units. An address bus or a data bus, for example, may be used for the storage medium reader 180.

In the multifunction product 100 having such a configuration, a scan job can be issued by selecting the scanner engine 140, for example. A print job can be issued by selecting the printer engine 150. A copy job can be issued by selecting the scanner engine 140 and the printer engine 150. A facsimile reception job and a facsimile transmission job can be issued by selecting the scanner engine 140, the printer engine 150, and the facsimile controlling unit 160.

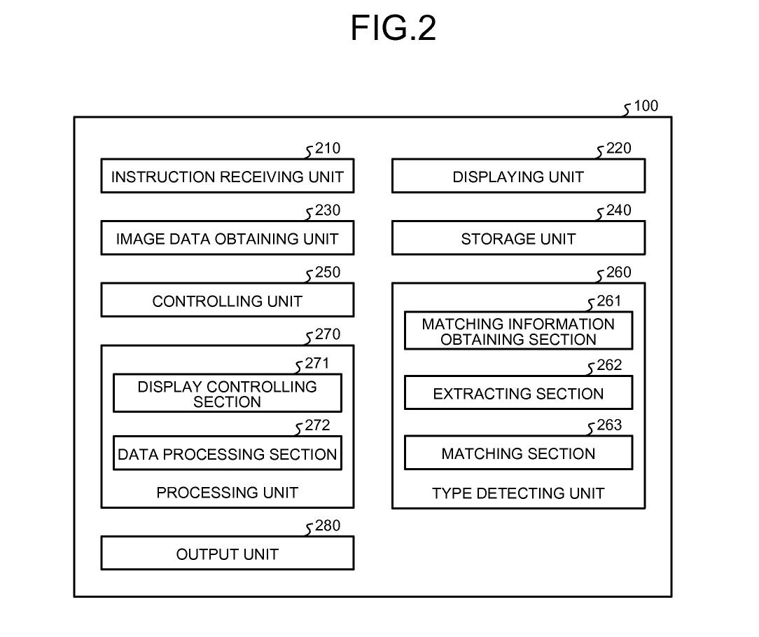

Functions included in the multifunction product 100 according to the first embodiment will now be explained. FIG. 2 is a functional block diagram of the multifunction product 100 according to the first embodiment.

As illustrated in FIG. 2, the multifunction product 100 according to the first embodiment includes an instruction receiving unit 210, a displaying unit 220, an image data obtaining unit 230, a storage unit 240, a controlling unit 250, a type detecting unit 260, a processing unit 270, and an output unit 280.

The instruction receiving unit 210 receives various instructions issued by a user, such as instructions of starting various processes, e.g., copying, or details of how image data should be processed. The instruction receiving unit 210 then sends the received instructions to the storage unit 240. The instruction receiving unit 210 may be realized by the operation panel 120, or may be realized by the communication interface 130. If the instruction receiving unit 210 is realized by the communication interface 130, an instruction issued by the user is received via a keyboard or the external device 131 on an information processing apparatus, for example.

The displaying unit 220 displays image data stored in the storage unit 240, and various information obtained from the controlling unit 250 or the processing unit 270. The displaying unit 220 may be realized by the operation panel 120, or may be realized by the communication interface 130. If the displaying unit 220 is realized by the communication interface 130, various information is displayed on the external device 131 connected via the communication interface 130.

The instruction receiving unit 210 and the displaying unit 220 may be realized as the same hardware. In other words, the instruction receiving unit 210 and the displaying unit 220 may be realized as the operation panel 120, or may be realized as the external device 131 connected via the communication interface 130. When the instruction receiving unit 210 and the displaying unit 220 are realized as the same hardware, the instruction receiving unit 210 and the displaying unit 220 function as an operation unit.

The image data obtaining unit 230 obtains image data of a document, and sends the obtained image data to the storage unit 240. The image data obtaining unit 230 may be realized by the scanner engine 140, or may be realized by the communication interface 130. If the image data obtaining unit 230 is realized by the scanner engine 140, the multifunction product 100 can obtain image data obtained by reading a document formed on paper that is a recording medium. On the contrary, if the image data obtaining unit 230 is realized by the communication interface 130, the multifunction product 100 can obtain the image data from the external device 131 such as an information processing apparatus.

The storage unit 240 stores therein various information, such as various instructions obtained from the instruction receiving unit 210, the image data obtained from the image data obtaining unit 230, and data for type detection used by the type detecting unit 260 to be explained later. The storage unit 240 is implemented by the RAM 112, the ROM 113, or the HDD 170 in the controller 110.

The controlling unit 250 not only reads (loads) and removes (deletes) various data stored in the storage unit 240, but also controls the instruction receiving unit 210, the displaying unit 220, the image data obtaining unit 230, the type detecting unit 260, the processing unit 270, and the output unit 280. The controlling unit 250 is realized by the controller 110. More specifically, the CPU 111 included in the controller 110 executes a process based on a computer program loaded into the RAM 112 to realize the controlling unit 250. The controls performed by the controlling unit 250 will be described later in detail.

The type detecting unit 260 detects a type of a document that is the source of image data. The type detecting unit 260 is realized by the controller 110. More specifically, the type detecting unit 260 is implemented by the CPU 111 executing a process based on a computer program loaded into the RAM 112 in the controller 110.

The type detecting unit 260 includes a matching information obtaining section 261, an extracting section 262, and a matching section 263.

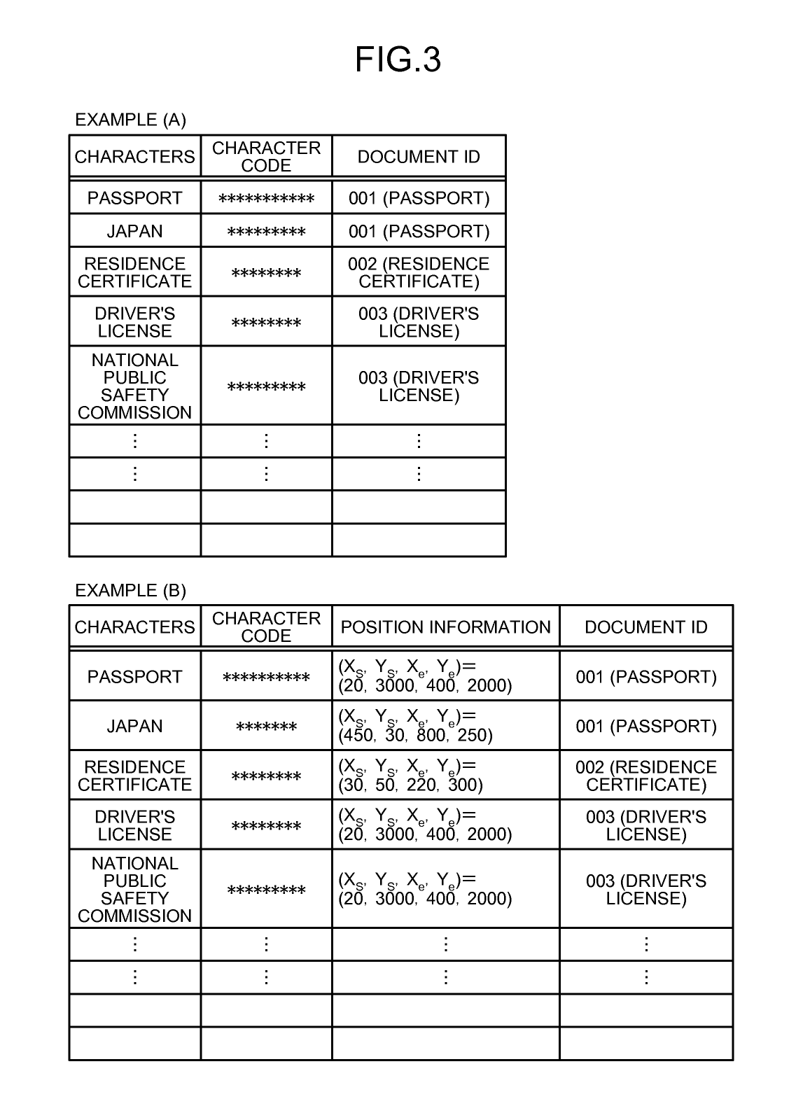

The matching information obtaining section 261 obtains information to be used for detecting a type of a document (hereinafter, referred to as “data for type detection”) from the storage unit 240. FIG. 3 is a schematic of an example of the data for type detection stored in the storage unit 240. As illustrated in FIG. 3, the data for type detection may be either (A) a character code or (B) a combination of a character code and position information.

In the explanation below, it is assumed that character codes are stored in the storage unit 240 in advance, and the matching information obtaining section 261 obtains a character code from the storage unit 240 (the example illustrated in FIG. 3(A)). The character code obtained by the matching information obtaining section 261 is the code of characters described in a confidential document containing confidential information. In other words, the storage unit 240 stores therein the codes of characters described in the confidential document in advance.

The confidential information is information that should be protected against external leakage, such as private information or corporate information. Examples of the confidential information include private information such as a photograph, an address, a name, an age, a telephone number, and a family register. Examples of the confidential document containing the confidential information include various certifications such as a passport, a health insurance card, a driver's license, an employee identification card, a residence certificate, a copy of a family register, and a contract, or a public utility bill.

When the matching information obtaining section 261 obtains a character code from the storage unit 240 as data for type detection, the extracting section 262 performs character recognition to the image data of a document obtained by the image data obtaining unit 230. The extracting section 262 then extracts a character code from the image data of the document as a result of the character recognition. Because the character recognition is a well-known technology, a detailed explanation thereof is omitted herein.

The matching section 263 checks matching of the character code obtained by the matching information obtaining section 261 and the character code extracted from the image data by the extracting section 262. As a result of checking, the matching section 263 uses the matched character code as a key to obtain information indicating a type of the document from the storage unit 240, and detects the type of the document. The matching section 263 then outputs document identification (ID) that is the result of the type detection to the controlling unit 250.

The detection of a document type will now be explained using a passport as an example of the document. A passport has fixed characters such as “Japan” or “PASSPORT”. Therefore, the data for type detection of the passport includes fixed characters such as “Japan” or “PASSPORT”. If the matching section 263 determines that some character codes corresponding to “Japan” or “PASSPORT” are included as a result of checking matching of the character code extracted from the image data by the extracting section 262 and the data for type detection, the matching section 263 detects that the type of the document that is the source of the image data is a passport. To prevent a detection error, a plurality of character codes may be used to determine the type of a document. In the example of the passport, the type of a document that is the source of the image data is detected to be a passport when both of the character code corresponding to “Japan” and the character code corresponding to “PASSPORT” are contained in the image data.

In another example used in an explanation below, the character code and the position information are stored in the storage unit 240 in advance, and obtained by the matching information obtaining section 261 as the data for type detection (the example illustrated in. FIG. 3(B)). The character code obtained by the matching information obtaining section 261 is the code of characters described in the confidential document containing confidential information. The position information is information indicating the position of the characters in the confidential document, e.g., coordinate values of the starting point and the ending point of a character area. In other words, the storage unit 240 stores therein the code of the characters described in confidential document, in association with the position information thereof.

When the matching information obtaining section 261 obtains a character code and position information from the storage unit 240 as the data for type detection, the extracting section 262 performs character recognition to the image data of a document obtained by the image data obtaining unit 230. The extracting section 262 then extracts a character code from the image data of the document as a result of the character recognition. The extracting section 262 also extracts the position information of the characters whose character code is extracted. Because the character recognition and character position information obtaining are well-known technologies, detailed explanations thereof are omitted herein.

The matching section 263 checks matching of the character code and the position information obtained by the matching information obtaining section 261 and those extracted by the extracting section 262. As a result of checking, if the difference in the position information between the two falls within a predetermined range, and if the character codes are matched, the type detecting unit 260 detects that the document that is a source of the image data is a confidential document containing confidential information. The matching section 263 then outputs the document ID, which is a result of the detection, to the controlling unit 250.

The document type detection will now be explained using an example where the document is a passport. A passport contains fixed characters such as “Japan” and “PASSPORT” placed in predetermined positions. Therefore, the data for type detection of a passport includes fixed characters such as “Japan” and “PASSPORT”, and position information thereof. If the matching section 263 determines that the character codes corresponding to “Japan” and “PASSPORT” are included in the predetermined positions as a result of checking matching of the character code and the position information extracted by the extracting section 262 from the image data and those included in the data for type detection, the matching section 263 detects that the type of the document that is the source of the image data is a passport. To prevent a detection error, a plurality of character codes may be used to determine the type of a document. In the example of the passport, the type of a document that is the source of the image data is determined to be a passport when both of the character code corresponding to “Japan” and the character code corresponding to “PASSPORT” are contained in the predetermined positions of the image data.

The processing unit 270 is realized by the controller 110. In other words, the CPU 111 included in the controller 110 executes a process based on a computer program loaded into the RAM 112 to realize the processing unit 270. More particularly, the CPU 111 loads an application program for realizing the processing unit 270 from the ROM 113 or the HDD 170 into the RAM 112. The CPU 111 then executes the process based on the application program loaded into the RAM 112 to realize the processing unit 270.

When the controlling unit 250 receives a detection result indicating that the document is a confidential document as a result of the type detection performed by the type detecting unit 260, the controlling unit 250 starts or boots the processing unit 270. The processing unit 270 obtains a menu for allowing the user to instruct details of how the image data should be processed or the image data of the document from the storage unit 240, and causes the displaying unit 220 to display the menu or the image data. The processing unit 270 may also causes the displaying unit 220 to display the menu as well as the image data of the document. In other words, by starting the processing unit 270, the controlling unit 250 achieves a function of displaying the menu for allowing the user to instruct the details of how the image data should be processed, or the image data of the document. Furthermore, by starting the processing unit 270, the controlling unit 250 can achieve the function of displaying the image data of the input document as well as the menu for allowing the user to instruct the details of how the image data should be processed.

The processing unit 270 includes a display controlling section 271 and a data processing section 272.

Once the controlling unit 250 starts (boots) the processing unit 270, the display controlling section 271 included in the processing unit 270 causes the displaying unit 220 to display a menu for receiving an instruction about the details of the process from the user. The display controlling section 271 may also cause the displaying unit 220 to display the image data of the document as well.

The data processing section 272 obtains the instruction about the processing input by the user via the instruction receiving unit 210 and stored in the storage unit 240, and applies a process to the image data according to an obtained user instruction. The display controlling section 271 then causes the displaying unit 220 to display the processed image data. The data processing section 272 stacks a history of the processes performed according to user instructions in the RAM 112, for example. Using the stacked history of the processes, the data processing section 272 can repeat a process, or cancel the process and revert the image data back to the original condition before the process is applied.

The image data to be processed is image data of a document. When the image data of a document has already been processed by the data processing section 272, the data processing section 272 processes the image data already processed thereby. By performing such a process, a process can be applied to the image data successively according to a user instruction, to improve the usability for the user.

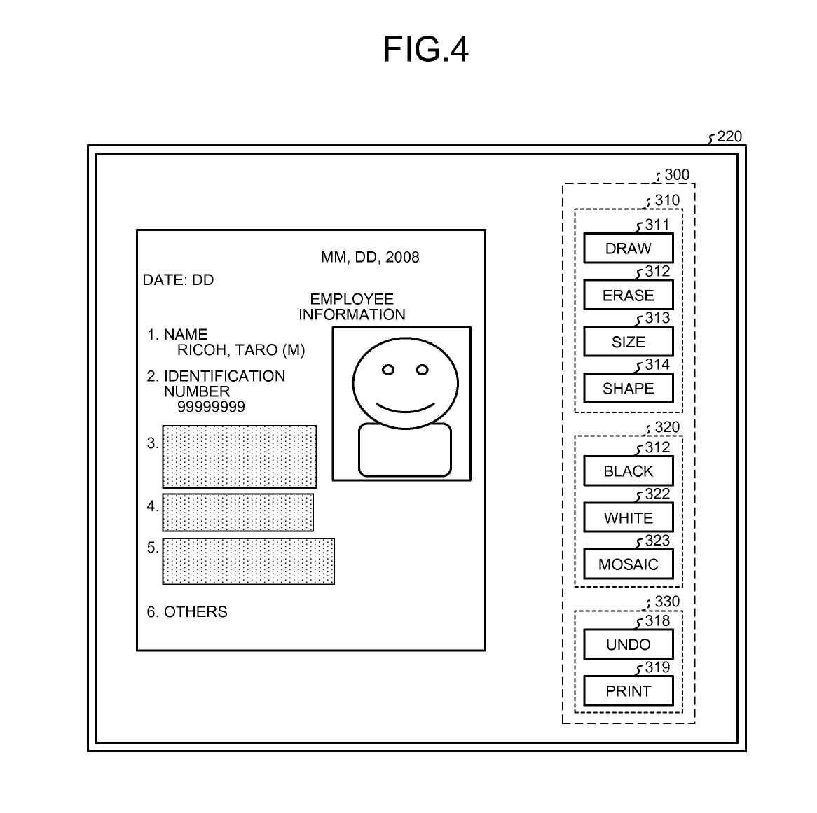

FIG. 4 is a schematic of an example of image data that the display controlling section 271 causes the displaying unit 220 to display, and more specifically, an example of image data displayed with a menu.

As illustrated in FIG. 4, the image data of the document is displayed at the left side of the displaying unit 220 when seen in the direction facing thereto, and icons 300 that are a menu, used by the data processing section 272 upon processing the image data and allowing the user to give an instruction, are displayed at the right side. In the example illustrated in FIG. 4, nine icons are arranged sequentially from the top to the bottom. These icons being displayed can be classified into three groups.

The four icons from the top are processing position icons 310, the fifth to the seventh icons from the top are process type icons 320, and the two icons at the bottom are sub icons 330.

The processing position icons 310 function as icons for allowing the user to instruct the position of information that the user does not want to have output. In other words, the processing position icons 310 can also be said to be the icons for allowing the user to specify the position where the process is applied to prevent the information from being output. The processing position icons 310 include a drawing icon 311, an erasing icon 312, a size adjusting icon 313, and a shape drawing icon 314.

The drawing icon 311 is an icon used mainly upon processing the image data. When the drawing icon 311 is selected, the processing unit 270 transits to a mode allowing the user to specify an area that should be processed (hereinafter, referred to as “area to be processed”) by means of a marker, for example.

The erasing icon 312 functions as an icon for causing the processing unit 270 to transit to a mode having an opposite function to that of the drawing icon 311. In other words, when the erasing icon 312 is selected, the type detecting unit 260 is caused to transit to a mode allowing the user to cancel the instruction of the area to be processed.

The size adjusting icon 313 functions as an icon for causing the processing unit 270 to transit to a mode allowing the user to adjust the size of the area to be processed. When the size adjusting icon 313 is specified, the user can change the size of the area to be processed that has been specified with the drawing icon 311 or the size adjusting icon 313.

The shape drawing icon 314 functions as an icon for allowing the user to specify the area to be processed using a preset default shape (for example, a rectangle or a circle). In other words, when the shape drawing icon 314 is selected, the processing unit 270 is caused to transit to a mode allowing the user to specify the area to be processed using a preset shape.

If the user specifies a point in the image data via the instruction receiving unit 210 such as the operation panel 120, the display controlling section 271 causes the displaying unit 220 to display a preset shape, e.g., a rectangle of a predetermined size, using the specified point as a center. The area to be processed can then be specified by moving the displayed shape according to user instructions. Upon moving the shape, each coordinate of the shape may be changed according to a user instruction.

The process type icons 320 function as icons for allowing the user to select how the area to be processed, which is specified using the processing position icons 310, should be processed. The process type icons 320 include color specifying icons 321 and 322, and a pixelization icon 323. In the example illustrated in FIG. 4, for the color specifying icons 321 and 322, black and white are used as colors that can be specified.

The color specifying icons 321 and 322 function as icons for allowing the user to specify the color of the area to be processed that is specified with the processing position icons 310. If the color specifying icon 321 or the color specifying icon 322 is specified while the area to be processed is specified by the user, the type detecting unit 260 is caused to transit to a mode for adjusting the color of the area to be processed. In the first embodiment, a color is set to each of the color specifying icons; however, as to how the color is specified, the user may be allowed to specify a color after selecting the color specifying icon.

The pixelization icon 323 functions as an icon for applying pixelization to the area to be processed specified with the processing position icons 310. If the pixelization icon 323 is specified while the area to be processed is specified by the user, the area to be processed is displayed using pixelization.

The sub icons 330 are icons for controlling the entire processing unit 270. The sub icons 330 include a cancel icon 318 and a print icon 319. The cancel icon 318 functions as an icon for allowing the process specified using the processing position icons 310 and the process type icons 320 to be cancelled. If the cancel icon 318 is specified while a process is specified by the user, the process being specified is cancelled. More specifically, the image data is reverted back to the condition before the process is applied, by referring to the history of the processes stacked by the data processing section 272. The print icon 319 functions as an icon for allowing the image to be output. When the print icon 319 is specified, the image is output. For example, if a process is specified using the processing position icons 310 and the process type icons 320, the image applied with the specified process is output when the print icon 319 is selected.

In the example illustrated in FIG. 4, the displaying unit 220 displays the image data obtained by the image data obtaining unit 230 and the menu for allowing the user to instruct the details about a process. Alternatively, on the image displayed on the displaying unit 220, the image data having undergone the process received by the instruction receiving unit 210 may also be displayed.

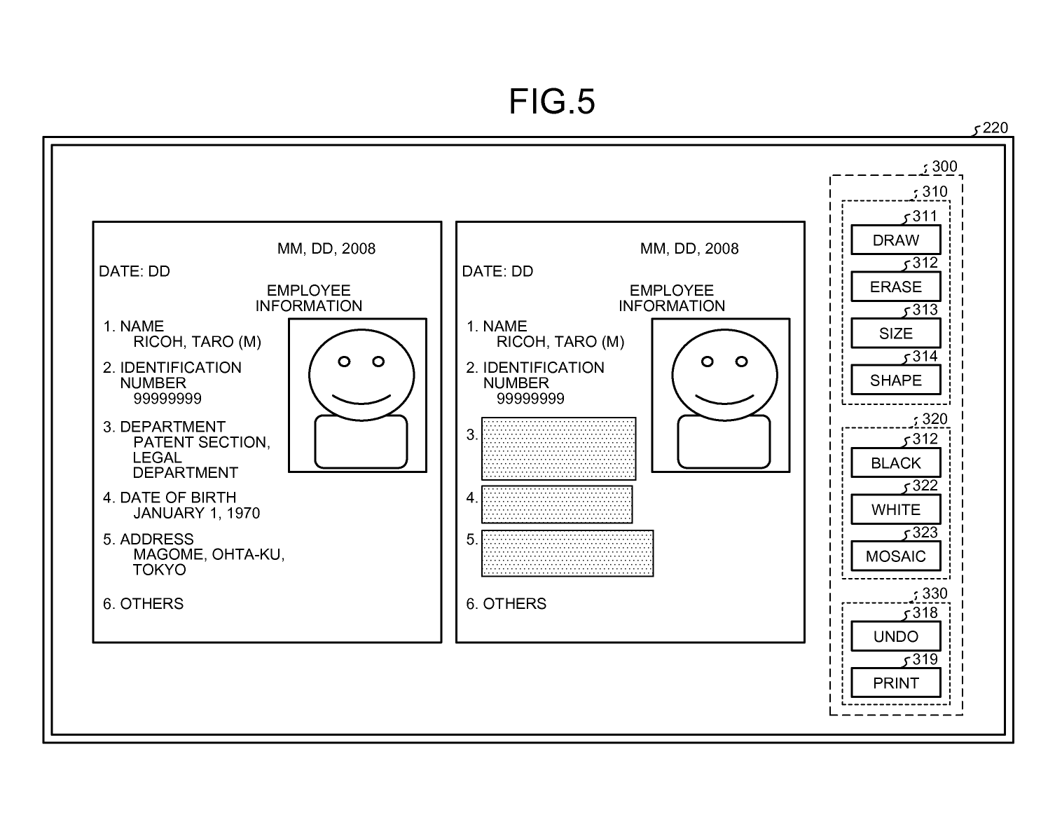

FIG. 5 is a schematic of an example of the image that the display controlling section 271 causes the displaying unit 220 to display, and more specifically, a schematic of an example of the image displayed on the displaying unit 220 and including the image data obtained by the image data obtaining unit 230, the menu for allowing the user to instruct the details of the process, and the image data having undergone the process received by the instruction receiving unit 210. As illustrated in FIG. 5, the displaying unit 220 displays the image data obtained by the image data obtaining unit 230 as well as the image data having undergone the process received by the instruction receiving unit 210 so that the user can easily understand the difference between the image data of the confidential document and the image data of the confidential document after being processed.

When the controlling unit 250 starts (boots) the processing unit 270, the output unit 280 outputs the image data that is the image data obtained from the image data obtaining unit 230 and being processed based on the information obtained from the processing unit 270. On the contrary, if the controlling unit 250 does not start the processing unit 270, the output unit 280 outputs the image data obtained from the image data obtaining unit 230 as it is. The output unit 280 may be realized by the communication interface 130, the printer engine 150, or the facsimile controlling unit 160.

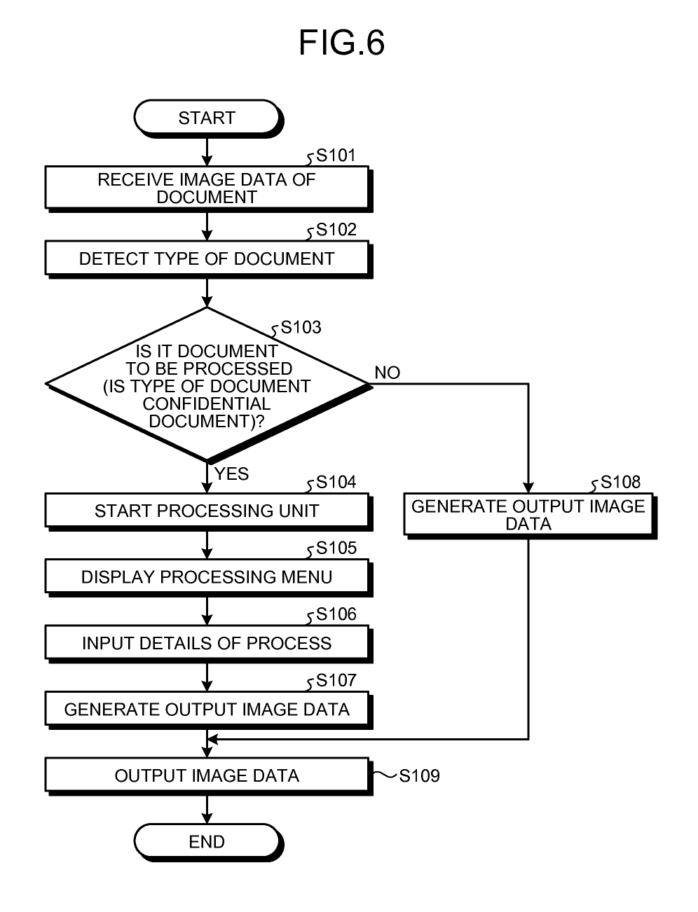

A process performed in the multifunction product 100 will now be explained. FIG. 6 is a flowchart for the multifunction product 100 according to the first embodiment, illustrating a process performed in the multifunction product 100.

As illustrated in FIG. 6, when the process is started, the multifunction product 100 receives the image data of a document through the image data obtaining unit 230 (S101). At S101, the obtained image data is stored in the storage unit 240 realized by the RAM 112 or the HDD 170.

The multifunction product 100 then detects the type of the document which is the source of the image data stored in the storage unit 240, using the type detecting unit 260 (S102). At S102, a detection result detected by the type detecting unit 260 is output to the controlling unit 250.

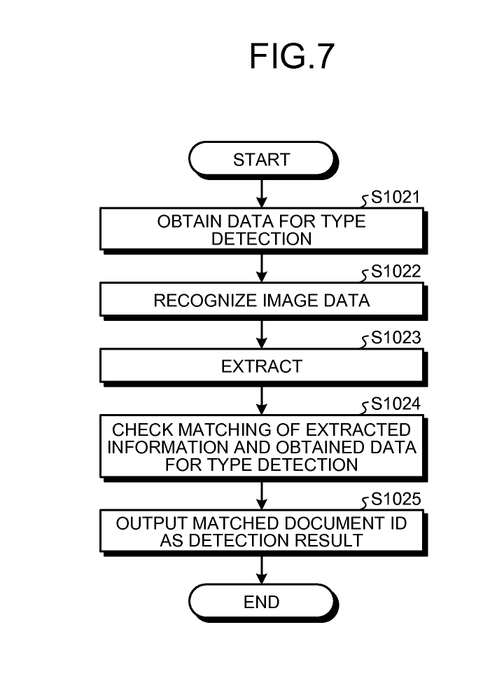

FIG. 7 is a flowchart of the document type detecting process. As illustrated in FIG. 7, in the type detecting unit 260, the matching information obtaining section 261 obtains the data for type detection from the storage unit 240 (S1021). The extracting section 262 then performs the recognition on the image data obtained by the image data obtaining unit 230 (S1022), and extracts character codes and position information therefrom (S1023). The matching section 263 then checks matching of the extracted information and the obtained data for type detection (S1024). The matching section 263 outputs a document ID from the data for type detection having the character code and the position information that match the extracted character code and the position information as a detection result (S1025).

As illustrated in FIG. 6, subsequently to S102, the controlling unit 250 determines if the processing unit 270 should be started based on the received detection result (S103). More specifically, the controlling unit 250 determines if the result of the detection performed by the type detecting unit 260 is a document of a predetermined type that is to be processed by the processing unit 270, that is, if the type of the document is a confidential document.

At S103, if the controlling unit 250 determines that the type of the document is the confidential document, and the processing unit 270 should be started (YES), the process goes to S104. On the contrary, if the controlling unit 250 determines that the type of the document is not the confidential document, and the processing unit 270 does not need to be started (NO), the process goes to S108.

At S104, the controlling unit 250 reads the application program for realizing the processing unit 270 from the storage unit 240, and starts the processing unit 270. Upon being started, the processing unit 270 causes the displaying unit 220 to display a processing menu to specify details of the process (S105).

The instruction receiving unit 210 then inputs the instruction related to the details of the process entered by the user via the processing menu to the storage unit 240 (S106). The processing unit 270 then applies the process according to the instruction stored in the storage unit 240 to the image data obtained by the image data obtaining unit 230 to generate image data applied with the process (output image data) (S107), and stores the generated output image data in the storage unit 240.

At S108, the controlling unit 250 generates the output image data by performing the process according to the instruction entered by the user via the instruction receiving unit 210 in advance (S108), e.g., when the image data is obtained by the image data obtaining unit 230, and stores the generated output image data in the storage unit 240. At S108, the process performed according to the instruction issued by the user may be a general image processing, such as tone correction or scaling.

The output unit 280 then outputs the output image data stored in the storage unit 240 in an output format according to an instruction issued by the user entered via the instruction receiving unit 210 (S109). The output format according to an instruction issued by the user includes an output made by controlling the printer engine 150 or the facsimile controlling unit 160, as well as an output to the HDD 170.

As explained above, in the first embodiment, because the controlling unit 250 starts or boots the processing unit 270 depending on the characters described in a document, a process intended by the user can be applied to image data upon outputting the image data of a predetermined document, such as a confidential document containing confidential information. Furthermore, for a confidential document containing confidential information, the controlling unit 250 starts the application program for processing the image data in a manner the user intended. Therefore, the user him/herself does not have to start the application program.

The storage medium 181 read by the storage medium reader 180 is not especially limited to the SD card, and may also be a memory-based storage device such as a compact flash (registered trademark) memory card, a smart media (registered trademark), a memory stick (registered trademark), or a picture card, or any other removable storage medium, used alone or in combination.

Each of the functions explained above can be realized by a computer-executable program described in a legacy programming language, such as the assembler, C, C++, C#, or Java (registered trademark), or an object-oriented programming language, and may be stored and distributed in an apparatus-readable recording medium, such as a ROM, an electrically erasable programmable ROM (EEPROM), an erasable programmable ROM (EPROM), a flash memory, a flexible disk, a compact disk ROM (CD-ROM), a compact disk rewritable (CD-RW), a digital versatile disk (DVD), a secure digital (SD) card, a magneto-optical (MO) disk. These programs may also be distributed from the external device 131 connected via the communication interface 130, or over the Internet.

### Second Embodiment

A second embodiment of the present invention will now be explained. In the second embodiment, the layout information of a document is used as the information for detecting the type of a document, and is different from the information used in detecting the type according to the first embodiment.

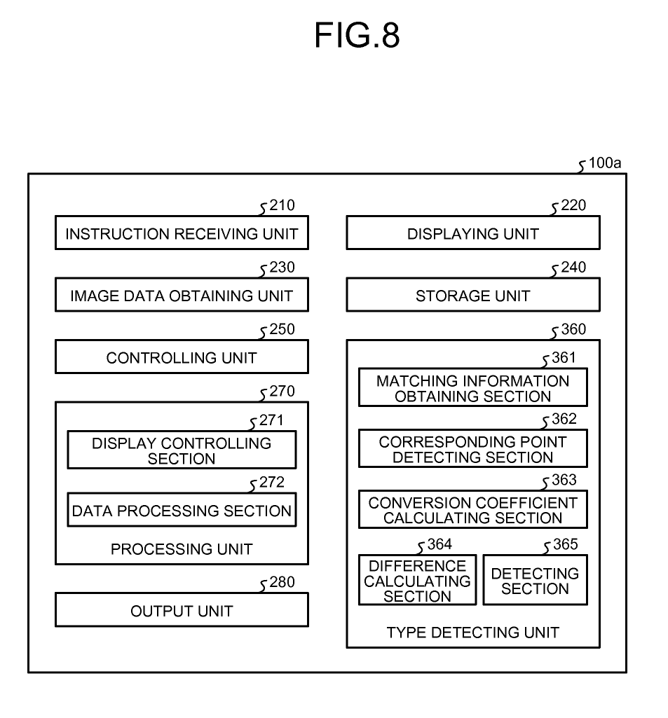

FIG. 8 is a functional block diagram of a multifunction product 100a according to the second embodiment. The multifunction product 100a according to the second embodiment has the same hardware configuration as that of the multifunction product 100 according to the first embodiment. Therefore, the explanations thereof are omitted herein.

As illustrated in FIG. 8, the multifunction product 100a according to the second embodiment includes the instruction receiving unit 210, the displaying unit 220, the image data obtaining unit 230, the storage unit 240, the controlling unit 250, a type detecting unit 360, the processing unit 270, and the output unit 280. The units other than the type detecting unit 360 are substantially the same as those according to the first embodiment. Therefore, a detailed explanation of each of the units is omitted hereunder.

The type detecting unit 360 detects a type of a document that is the source of image data. The type detecting unit 360 is realized by the controller 110. More specifically, in the controller 110, the CPU 111 performs a process based on a computer program loaded into the RAM 112 to realize the type detecting unit 360.

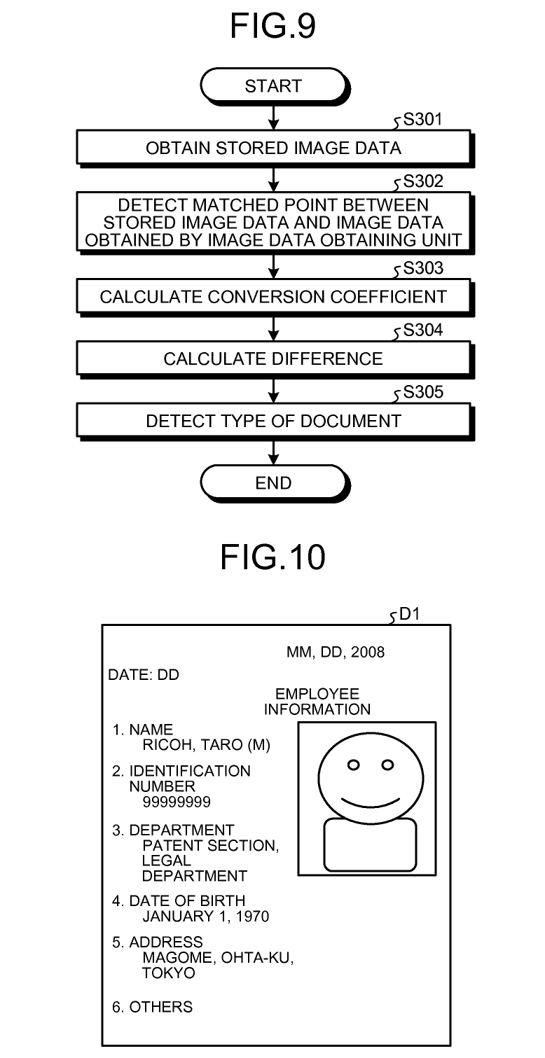

FIG. 9 is a flowchart of a process performed by the type detecting unit 360 according to the second embodiment. The process performed by the type detecting unit 360 will be explained with reference to FIG. 9, along with the explanations of FIG. 8.

As illustrated in FIG. 8, the type detecting unit 360 includes a matching information obtaining section 361, a corresponding point detecting section 362, a conversion coefficient calculating section 363, a difference calculating section 364, and a detecting section 365.

The matching information obtaining section 361 obtains stored image data from the storage unit 240 as the information used for detecting the type of a document (S301 in FIG. 9). The stored image data is image data of a confidential document containing confidential information, and is stored in the storage unit 240 in advance. The confidential information and the confidential document are the same as those according to the first embodiment. Therefore, explanations thereof are omitted herein.

FIG. 10 is a schematic of an example of stored image data D1 stored in the storage unit 240. As illustrated in FIG. 10, the storage unit 240 stores therein image data of an employee document that is a type of the confidential documents as the stored image data D1.

The corresponding point detecting section 362 detects a matched point between stored image data obtained by the matching information obtaining section 361 and the image data obtained by the image data obtaining unit 230 (S302 in FIG. 9). If a plurality of images is included in the stored image data obtained by the matching information obtaining section 361, the corresponding point detecting section 362 sequentially detects a matched point between each of the images included in the stored image data and the image data obtained by the image data obtaining unit 230.

As a method for detecting a corresponding point, the corresponding point detecting section 362 may detect such a corresponding point by comparing the coordinate values of the positions of ruled lines included in the image data, or the positions where characters unique to the document are printed, for example. If image data obtained from different documents are compared, printed characters that should be included in each of the image data may not be detected, or may be detected incorrectly.

The conversion coefficient calculating section 363 calculates a conversion coefficient (S303 in FIG. 9). The conversion coefficient herein means a coefficient included in a conversion equation that allows the coordinate values of one of the image data to be converted into the coordinate values of the other image data, such as an affine transformation coefficient.

The calculation of the conversion coefficient is explained using an example of the affine transformation. When a point in one of the image data is (x, y) and the corresponding point in the other image data is (X, Y), the following is established using a conversion equation of the affine transformation:

$$( \begin{matrix}X \\ Y\end{matrix} ) = ( \begin{matrix}a & b \\ c & d\end{matrix} ) ( \begin{matrix}x \\ y\end{matrix} ) + ( \begin{matrix}e \\ f\end{matrix} )$$

If six pairs of corresponding points (x, y) and (X, Y) are obtained, the equation will be a first-order simultaneous equations of six unknowns, and conversion coefficients a to f can be obtained.

The difference calculating section 364 calculates a difference between the stored image data and the image data obtained by the image data obtaining unit 230 (S304 in FIG. 9). The difference is obtained from the conversion coefficients calculated by the conversion coefficient calculating section 363. An example in which the difference is obtained from the affine transformation coefficient will now be explained.

The difference between the image data is obtained as a sum of the quantified “displacement”, “extension or contraction”, and “rotation” between the image data. The difference is calculated by summing the characterizing quantities defined as below and weighted appropriately:

Displacement: e2+f2

Extension or Contraction: |ad−bc|

Rotation: b2+c2

The detecting section 365 performs the process to each piece of the images included in the stored image data and the image obtained by the image data obtaining unit 230, and, amongst the images included in the stored image data, detects the type of the document corresponding to the image with the smallest difference as the type of the document (S305 in FIG. 9).

If the layout of each of the images included in the stored image data and that of the image obtained by the image data obtaining unit 230 do not match, a corresponding point cannot be found, or is found incorrectly. If a corresponding point cannot be found, the difference cannot be calculated. On the contrary, if a corresponding point is found incorrectly, the difference tends to indicate a value departed from the conversion coefficients in a larger degree than usual. Therefore, if the detecting section 365 does not detect a difference smaller than a predetermined threshold, the detecting section 365 determines that the image data obtained by the image data obtaining unit 230 is not the stored image data, that is, not the image data of a confidential document.

As described above, in the second embodiment, the type detecting unit 360 can detect the type of a document that is the source of the image data based on the layout of the image data. Therefore, by storing the image data of a document in the storage unit 240 in advance, the type detecting unit 360 can detect the type of the document. Furthermore, because the controlling unit 250 starts or boots the processing unit 270 depending on the result of the type detection upon outputting the image data of a predetermined document such as a confidential document containing confidential information, a process intended by the user can be applied to the image data. Furthermore, for a confidential document containing confidential information, the controlling unit 250 starts the application program for processing the image data in the manner the user intended. Therefore, the user does not have to start the application program him/herself.

The process performed by the type detecting unit 260 according to the first embodiment and the process performed by the type detecting unit 360 according to the second embodiment may be realized simultaneously. In other words, a configuration for detecting the type of a document based on the character codes and the layout information of the image data may be adopted. In such a configuration, because the type of a document is detected from both perspectives of the character codes and the layout information of the image data, the type of a document can be detected more accurately. Furthermore, even if the obtained image data is reduced or enlarged image data, the type of the document can be detected more reliably.

### Third Embodiment

A third embodiment of the present invention will now be explained. The third embodiment is different from the other embodiments in a menu that the processing unit causes the displaying unit to display. In other words, to realize the process, the processing unit according to the third embodiment uses a menu that is different from those according to the other embodiments.

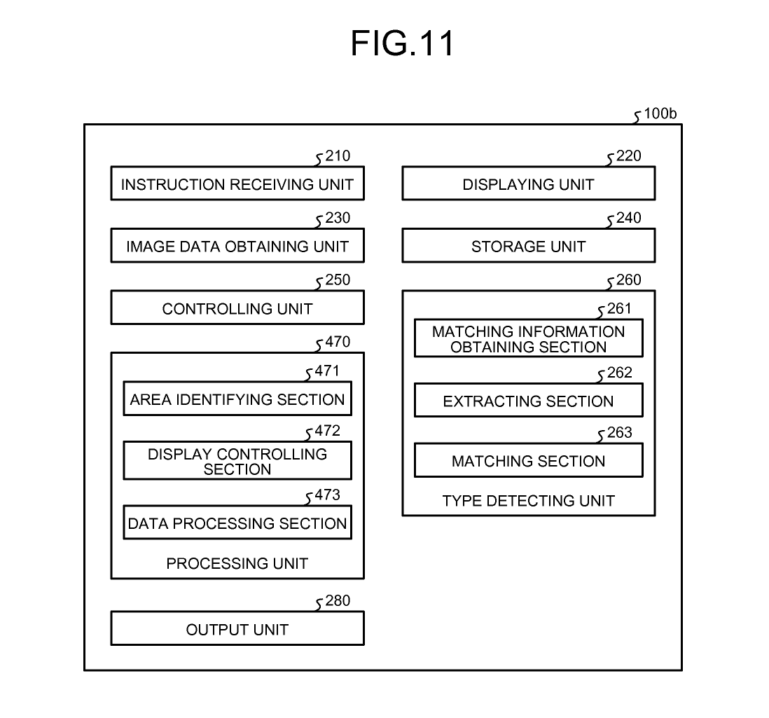

FIG. 11 is a functional block diagram of a multifunction product 100b according to the third embodiment. Because the multifunction product 100b according to the third embodiment has the same hardware configuration as the multifunction products 100 and 100a according to the first and the second embodiments, an explanation thereof is omitted herein.

As illustrated in FIG. 11, the multifunction product 100b according to the third embodiment includes the instruction receiving unit 210, the displaying unit 220, the image data obtaining unit 230, the storage unit 240, the controlling unit 250, the type detecting unit 260, a processing unit 470, and the output unit 280. The units other than the processing unit 470 are substantially the same as those according to the first embodiment. Therefore, a detailed explanation of each of such units is omitted hereunder.

The processing unit 470 is realized by the controller 110. More specifically, the CPU 111 in the controller 110 performs a process based on a computer program loaded into the RAM 112 to realize the processing unit 470. More particularly, the CPU 111 loads an application program for realizing the processing unit 470 from the ROM 113 or the HDD 170 into the RAM 112. The CPU 111 then executes the process based on the application program loaded into the RAM 112 to realize the processing unit 470.

The processing unit 470 is started by the controlling unit 250, and executes various processes. The controlling unit 250 starts the processing unit 470 when the controlling unit 250 receives a detection result indicating that the document that is a source of the image data is a confidential document from the type detecting unit 260.

The processing unit 470 causes the displaying unit 220 to display a menu for allowing the user to give an instruction about the details of how image data is to be processed. In other words, the controlling unit 250 functions to display the menu for allowing the user to give an instruction about the details of how image data is to be processed, by initiating the processing unit 470.

The processing unit 470 may cause the displaying unit 220 to display the menu as well as the image data of the document obtained by the image data obtaining unit 230. In such an example, the controlling unit 250 functions to cause the menu as well as the image data of the document to be displayed, by initiating the processing unit 470. If the image data is displayed with the menu, the user can sequentially check the image applied with a process instructed by the user, and the usability can be improved.

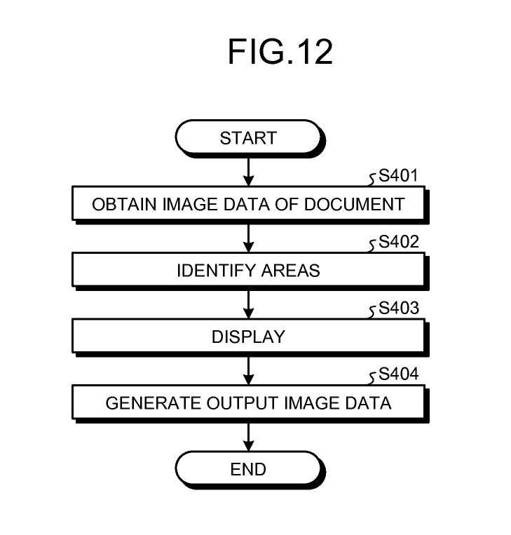

FIG. 12 is a flowchart of a process performed by the processing unit 470 according to the third embodiment. The process performed by the processing unit 470 will be explained with reference to FIG. 12, along with the explanations of FIG. 11.

As illustrated in FIG. 11, the processing unit 470 includes an area identifying section 471, a display controlling section 472, and a data processing section 473.

The area identifying section 471 obtains the image data of the document from the storage unit 240 (S401 in FIG. 12), and identifies an area such as a character area, a photograph area, or a table area included in the image data (S402 in FIG. 12). The area identifying section 471 obtains connected pixel components of the same color or similar colors, and uses information such as an arrangement or the size of a rectangle circumscribing the obtained connected components to identify the areas such as a character area or a photograph area. The area identifying section 471 then stores the result of the area identification, including the positions and the type thereof, in the storage unit 240. To identify the areas, various conventional technologies can be used. For example, technologies that have been proposed in Japanese Patent Application Laid-open No. H3-009489 or Japanese Patent Application Laid-open No. H7-322061 may be used.

The display controlling section 472 causes the displaying unit 220 to display the image data of the document to allow the user to give an instruction about the details of how the image data is to be processed (S403 in FIG. 12). The display controlling section 472 may also cause the displaying unit 220 to display a menu for allowing the user to instruct the details about the process, as well as the image data.

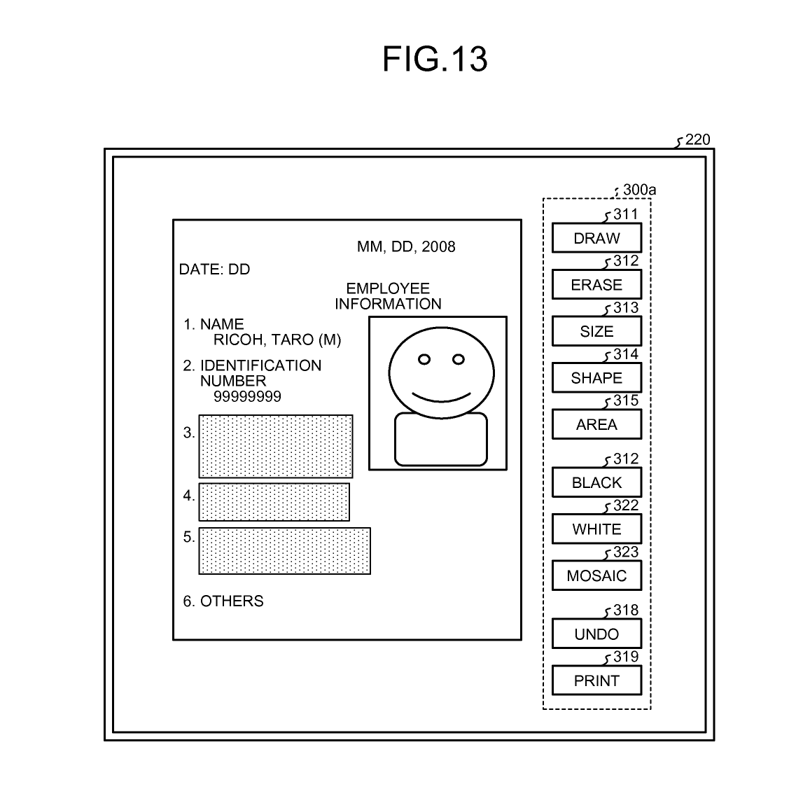

FIG. 13 is a schematic of an example of an image that the display controlling section 472 causes the displaying unit 220 to display, and more specifically, a schematic of an example where the image data is displayed with the menu.

As illustrated in FIG. 13, the image data of the document is displayed at the left side of the displaying unit 220 when seen in the direction facing thereto, and icons 300a being the menu allowing the user to enter information used in processing the image data are displayed at the right side. In the example illustrated in FIG. 13, ten icons, including an area specifying icon 315 not included in the icons 300 according to the first embodiment, are displayed as icons 300a.

The area specifying icon 315 functions as an icon for transiting into a mode for allowing the user to specify the area identified by the area identifying section 471 as the area to be processed. In other words, when the area specifying icon 315 is specified, the area identifying section 471 reads the area identification result stored in the storage unit 240 so that the user can specify each area that has been identified previously, such as a character area, a photograph area, or a table area, as the area to be processed. As to an operation performed to specify an area to be processed from these identified areas, the identified areas may be displayed in a selectable manner, e.g., by being masked, to receive a selecting operation performed by the user. In this manner, the user can specify the area to be processed with a simple operation.

The data processing section 473 applies a process to the image data according to the user instruction given via the menu, to generate the image data applied with the process (output image data) (S404 in FIG. 12).

### Fourth Embodiment

A fourth embodiment of the present invention will now be explained. The fourth embodiment is different from the other embodiments in that a mode for preventing information leakage (a first mode) and a mode other than such a mode (a second mode) are switchable, and the processing unit can be started only when the multifunction product is at the first mode.

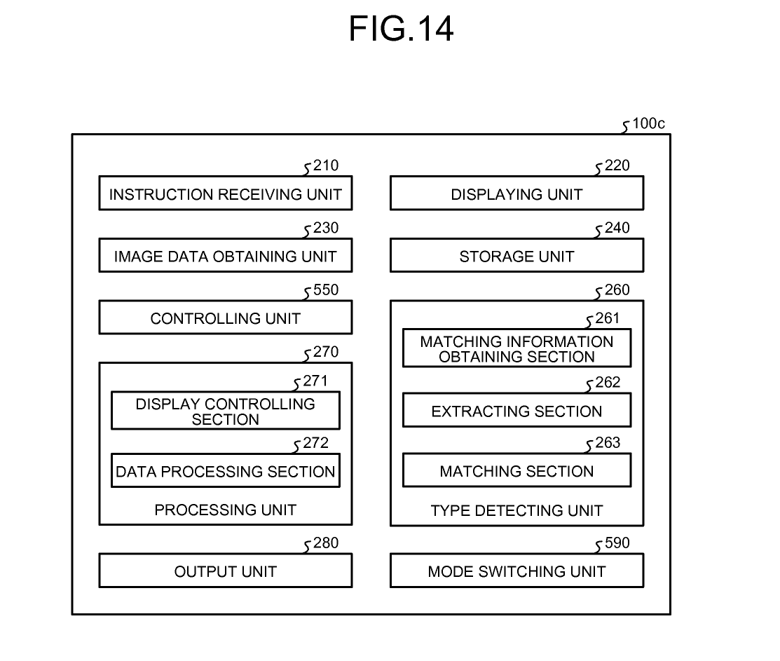

FIG. 14 is a functional block diagram of a multifunction product 100c according to the fourth embodiment. Because the multifunction product 100c according to the fourth embodiment has the same hardware configuration as the multifunction products 100 according to the first embodiment, an explanation thereof is omitted herein.

As illustrated in FIG. 14, the multifunction product 100c according to the fourth embodiment includes the instruction receiving unit 210, the displaying unit 220, the image data obtaining unit 230, the storage unit 240, the type detecting unit 260, the processing unit 270, the output unit 280, a controlling unit 550, and a mode switching unit 590. The units other than the controlling unit 550 and the mode switching unit 590 are substantially the same as those according to the first embodiment. Therefore, a detailed explanation of each of these units is omitted hereunder.

The controlling unit 550 not only reads (loads) and removes (deletes) various data stored in the storage unit 240, but also controls the instruction receiving unit 210, the displaying unit 220, the image data obtaining unit 230, the type detecting unit 260, the processing unit 270, the output unit 280, and the mode switching unit 590. The controlling unit 550 is realized by the controller 110. More specifically, the CPU 111 included in the controller 110 executes a process based on a computer program loaded into the RAM 112 to realize the controlling unit 550. The controlling unit 550 performs the same controls as the controlling unit 250 according to the other embodiments, except for performs a control corresponding to an operation mode switched by the mode switching unit 590.

The mode switching unit 590 switches the operation mode of the multifunction product 100c to one of the first mode or the second mode. More specifically, the mode switching unit 590 causes the displaying unit 220 to display a menu for receiving a switching instruction from the user, and switches the operation mode of the multifunction product 100c according to the instruction entered via the instruction receiving unit 210. For example, the mode switching unit 590 causes the displaying unit 220 to display icons for allowing the user to select the first mode or the second mode, and receives a selecting instruction from the user via the instruction receiving unit 210, to switch the operation mode. Upon receiving the selecting instruction from the user, the user may be requested to enter an administrative password, and the mode switching operation may be made effective only if a password is matched with the administrative password is entered. In this situation, only certain people, such as an administrator, are permitted to switch the mode.

The mode switching unit 590 is realized by the controller 110. More specifically, in the controller 110, the CPU 111 performs a process based on a computer program loaded into the RAM 112 to realize the mode switching unit 590.

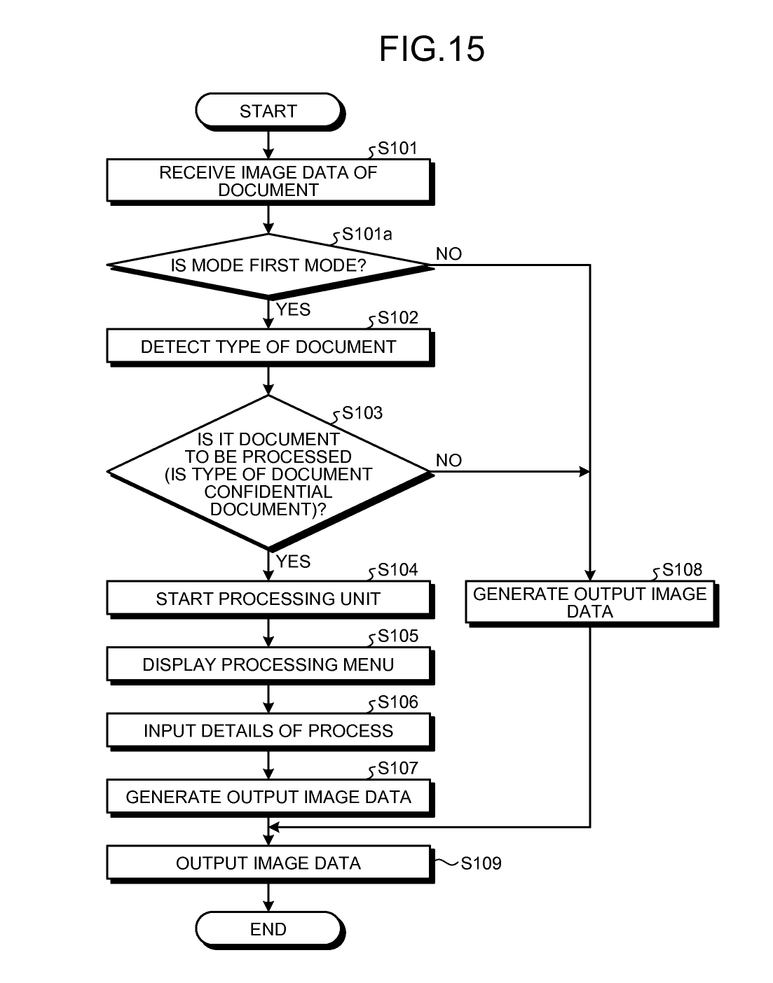

FIG. 15 is a flowchart for the multifunction product 100c according to the fourth embodiment, illustrating a process performed in the multifunction product 100c. As illustrated in FIG. 15, at S101a following S101, the controlling unit 550 included in the multifunction product 100c determines if the operation mode switched by the mode switching unit 590 is the first mode.

If the operation mode is the first mode (Yes at S101a), the controlling unit 550 transits the process to S102. If the operation mode is not the first mode, that is, if the operation mode is the second mode (No at S101a), the controlling unit 550 transits the process to S108. If the second mode is a mode for performing a prohibiting process to prevent a fraud copy of a banknote from being made, for example, the controlling unit 550 may check if the document is a document that is to be applied with such a prohibiting process (e.g., detects if the document is a banknote) at S108, and, if the document is a document to be applied with the prohibiting process, the document may be applied with the prohibiting process (for example, causing the document not to be output, or printing the output painted all black).

Therefore, in the multifunction product 100c, only when the multifunction product 100c is at the first mode for preventing the information leakage, the processing unit 270 for applying a process intended by the user to a predetermined document, e.g., a confidential document, can be started. Therefore, if such a process is not required even if the document is a confidential document, the multifunction product 100c can be switched to the second mode, to prevent the processing unit 270 from being started unexpectedly.

The exemplary embodiments of the present invention are explained above with reference to the accompanying drawings. However, it should be needless to say that the present invention is not limited to such examples. It is obvious that those skilled in the art can think of various variations and modifications thereof within the scope of the appended claims, and it should be understood that the variations and the modifications naturally belong to the technical scope of the present invention.

For example, in the explanations of the embodiments, the image processing apparatus according to the present invention is applied to a multifunction product having at least two of a copier function, a printing function, a scanner function, and a facsimile function. However, the image processing apparatus according to the present invention may be applied to any apparatus that performs an imaging process and makes an output (including image formation) such as a copier, a printer, a scanner, and a facsimile machine.

1.-13. (canceled)

14. An image processing apparatus that obtains image data of a document in response to an instruction from a user, and processes and outputs the image data thus obtained, the image processing apparatus comprising:
a type detecting unit that detects a type of the document;
an area identifying unit that identifies an area included in the image data thus obtained as one of a character area, a photograph area, and a table area;
a processing unit that receives, from the user, an instruction to specify the area, which is one of the character area, the photograph area, and the table area, included in the image data thus obtained, and selectively applies a process to confidential information in the area thus specified in the image data thus obtained based on set details of the process or selectively leaves the confidential information in the area thus specified in the image data thus obtained unprocessed based on set details of the process; and
a controlling unit that starts the processing unit when the type of the document thus detected is a predetermined type.

15. The image processing apparatus according to claim 14, wherein the controlling unit starts the processing unit to cause a displaying unit to display a menu for allowing the user to instruct details of the process.

16. The image processing apparatus according to claim 15, wherein the controlling unit causes the displaying unit to display the menu and the image data thus obtained.

17. The image processing apparatus according to claim 14, wherein the controlling unit causes the displaying unit to display the menu, the image data thus obtained, and the image data having undergone the process.

18. The image processing apparatus according to claim 14, further comprising a mode switching unit that switches mode between a first mode for preventing information leakage and a second mode different from the first mode, wherein in the first mode, the controlling unit starts the processing

19. The image processing apparatus according to claim 18, wherein the type detecting unit detects the type of the document only in the first mode.

20. The image processing apparatus according to claim 14, further comprising a key recognizing unit that recognizes a predetermined key included in the image data thus obtained, wherein
the type detecting unit detects a document type associated with the key recognized by the key recognizing unit as a detection result from a storage unit that stores therein keys and document types in an associated manner.

21. A computer program product that, when executed, causing a computer that obtains image data of a document in response to an instruction from a user to process and output the image data thus obtained to perform:
a step of detecting a type of the document;
a step of identifying an area included in the image data thus obtained as one of a character area, a photograph area, and a table area;
a step of receiving, from the user, an instruction to specify the area, which is one of the character area, the photograph area, and the table area, included in the image data thus obtained;
a step of displaying a menu for applying a process to the image data thus obtained on a displaying unit when the type of the document thus detected is a predetermined type; and
a step of selectively applying a process to confidential information in the area thus specified in the image data thus obtained based on details of the process set in the menu thus displayed or selectively leaving the confidential information in the area thus specified in the image data thus obtained unprocessed based on details of the process set in the menu thus displayed.

22. The computer program product according to claim 21, herein the step of displaying includes displaying the menu and the image data of the document.

23. The computer program product according to claim 22, wherein the step of displaying includes displaying the menu, the image data thus obtained, and the image data having undergone the process.

24. The computer program product according to claim 21, further causing the computer to perform a step of switching mode between a first mode for preventing information leakage and a second mode different from the first mode, wherein the menu is displayed at the step of displaying in the first mode.

25. The computer program product according to claim 24, wherein the type of the document is detected at the step of detecting only in the first mode.

26. The computer program product according to claim 21, further causing the computer to perform a step of recognizing a predetermined key included in the image data thus obtained, wherein
the step of detecting includes detecting a document type associated with the key recognized at the step of recognizing as a detection result from a storage unit that stores therein keys and document types in an associated manner.
